(19) United States
(12) Patent Application Publication
(10) Pub. No.: US 2012/0312603 A1
(43) Pub. Date: Dec. 13, 2012

(54) OPTIMIZATION OF DRILL BIT CUTTING STRUCTURE

(75) Inventors: Christopher Propes, Montgomery, TX (US); Curtis Lanning, Montgomery, TX (US)

(73) Assignee: NATIONAL OILWELL DHT, L.P., Houston, TX (US)

(21) Appl. No.: 13/156,773

(22) Filed: Jun. 9, 2011

(51) Int. Cl. E21B 10/43; G06F 17/50; G06G 7/48

(52) U.S. Cl. 175/431; 703/7

(57) ABSTRACT

Disclosed is method for designing a fixed cutter drill bit comprising: (a) defining initial primary placement parameters for primary cutter elements; (b) repeatedly: selecting back up placement parameters for back up cutter elements; applying to a simulated formation a bit design having the combination of the defined initial primary placement parameters and the selected back up placement parameters; using the combination in the simulation and generating a value representative of a first design criteria of interest (such as resultant force on a cutter element, total out-of-balance force on the bit, resistance to slip stick, and resistance to bit vibration); comparing the generated value to a first predetermined acceptable value.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field of Technology

The disclosure relates generally to earth-boring bits used to drill a borehole for the recovery of oil, gas or minerals. More particularly, this disclosure relates to methods for designing fixed cutter drill bits, and to the bits made according to those methods.

2. Background Information

To drill a well, an earth-boring drill bit is mounted on the lower end of a drill string and the drill string is rotated while weight is applied. In this manner, the rotating drill bit engages the earthen formation and drills a borehole toward a target zone. The borehole created will have a diameter generally equal to the diameter or “gage” of the drill bit.

Drilling a borehole is extremely costly, with the cost being proportional to the total time it takes to drill to the targeted depth and location. In turn, the time spent drilling the well is greatly affected by the bit's rate of penetration (“ROP”) and the number of times the bit must be changed before reaching the targeted formation, as is necessary, for example, when the bit becomes worn or damaged. Whenever a bit must be changed, the entire drill string, which is made up of discrete sections of drill pipe that have been threaded together and that may be miles long, must be retrieved from the borehole, section by section. Once the drill string has been retrieved and the new bit installed, the bit must be lowered back to the bottom of the borehole. This is accomplished by reconstructing the drill string, section by section. This process, known as a “trip” of the drill string, requires considerable time, effort and expense. Accordingly, it is desirable to employ drill bits that drill faster and for longer durations.

One type of conventional bit is a fixed cutter bit having a bit body with a number of cutter elements secured thereto. In a typical fixed cutter bit, each cutter element includes an elongate and generally cylindrical support member that is formed of tungsten carbide and retained in a pocket formed in the surface of one of several blades on the bit body. This support serves as a substrate for the cutting face made of polycrystalline diamond (“PCD”) or other superabrasive material, such as cubic boron nitride, thermally stable diamond, polycrystalline cubic boron nitride, or ultrahard tungsten carbide (meaning a tungsten carbide material having a wear-resistance that is greater than the wear-resistance of the material forming the substrate). For convenience, as used herein, reference to a “PCD cutting element” refers to a cutter element employing a hard cutting layer of polycrystalline diamond or other superabrasive material such as cubic boron nitride, thermally stable diamond, polycrystalline cubic boron nitride, or ultrahard tungsten carbide. The cutting face generally faces in the direction of bit rotation and scrapes, cuts, and removes formation material as the bit is rotated.

A bit's ROP and its durability may be substantially affected by the placement and orientation of the cutter elements on the bit. Designers face substantial challenges in designing a fixed cutter bit that is both fast-drilling (has a high ROP) and that will drill for long intervals before having to be replaced (i.e. is durable). This task often requires a compromise in design. For example, a bit design intended to have a high ROP may also be a design leading to an excessive resultant force being applied to one or more of the cutter elements, causing the elements to wear prematurely or to break. Excessive wear or cutter damage may lead to a reduction in ROP and bit life, and thus necessitate a costly and premature trip of the drill string. Thus, it may be necessary to sacrifice ROP in order to design and produce a bit with sufficient durability.

Other design criteria come into play in designing a fixed cutter bit. For example, in many applications, it is important that the forces applied to the bit during drilling be balanced to a substantial degree. Put another way, in many drilling applications, it is important that the resultant out-of-balance force that the formation applies to the bit during drilling be minimized. The positions of the cutter elements on the bit and how they are oriented will impact significantly the out of balance force applied to the bit.

Accordingly, there remains a need in the art for a fixed cutter bit and cutting structure capable of enhanced ROP and greater bit life, while minimizing certain detrimental effects. A method to optimize cutter element placement parameters to achieve important design criteria would be welcomed by the industry.

### SUMMARY OF THE DISCLOSURE

Disclosed herein are methods for designing a fixed cutter drill bit and optimizing its cutting structure. One such method includes: (a) defining initial placement parameters for primary cutter elements and backup cutter elements; (b) applying in a drilling simulation a drill bit having the defined initial placement parameters and producing a generated value of at least a first design criteria of interest; (c) determining whether the generated value meets a predetermined value for the first design criteria; (d) redefining at least one placement parameter of at least one of the backup cutter elements; (e) applying in a drilling simulation a drill bit having the redefined placement parameters and producing a new generated value for the first design criteria; (f) determining whether the new generated value meets the predetermined value; and (g) repeating steps (d), (e) and (f). Steps (d), (e) and (f) may be repeated at least until the new generated value meets the predetermined value of the first design criteria of interest, or until a plurality of new generated values are determined that meet the predetermined value. The method may also include: (h) after a new generated value is determined to meet the predetermined value of the first design criteria, selecting a second and different design criteria of interest; (i) applying in a drilling simulation a drill bit having the initial placement parameters of the primary cutter elements and the redefined placement parameters of the back up cutter elements that generated a value that met the predetermined value for the first design criteria, and producing a generated value of said second design criteria of interest; (j) determining whether the generated value of the second design criteria of interest meets a predetermined value for the second design criteria; (k) redefining at least one placement parameter of at least one of the backup cutter elements; (l) applying in a drilling simulation a drill bit having the initial placement parameters of the primary cutter elements and the redefined placement parameters for the backup cutter elements of step (k), and producing a new generated value for the second design criteria of interest; (m) determining whether the new generated value for the second design criteria of interest of step (l) meets the predetermined value for the second design criteria; and (n) repeating steps (k), (l) and (m).

In another embodiment, the design method includes (a) defining initial primary placement parameters for primary cutter elements; (b) repeatedly: selecting back up placement parameters for back up cutter elements; applying to a simulated formation a bit design having the combination of the defined initial primary placement parameters and the selected back up placement parameters; using the combination in the simulation and generating a value representative of a first design criteria of interest (such as resultant force on a cutter element, total out-of-balance force on the bit, resistance to slip stick, and resistance to bit vibration); comparing the generated value to a first predetermined acceptable value. This method may include performing step (b) at least until one combination or a plurality of combinations are found that meet the first predetermined acceptable value. The method may also include: (c) for a combination that produces a generated value that meets the first predetermined acceptable value, repeatedly applying to a simulated formation a drill bit design having the combination; using the combination and producing in the simulation a generated value representative of a second design criteria of interest; comparing the generated value of the second design criteria to a second predetermined acceptable value.

In a further embodiment, the design method includes: (a) determining initial placement parameters for primary and backup cutter elements; (b) calculating through a simulation the resultant force on each of the primary cutter elements in at least a given region on the bit; (c) comparing the calculated resultant force on each primary cutter element in the given region to a predetermined acceptable value; (d) adjusting at least one placement parameter for at least one backup cutter element; and (e) repeating steps (b) through (d) at least until the calculated resultant force on each primary cutter element in the given region is within acceptable limits.

Thus, embodiments described herein comprise a combination of features and advantages intended to address various shortcomings associated with certain prior apparatus and methods. The various features and characteristics described above, as well as others, will be readily apparent to those skilled in the art upon reading the following detailed description, and by referring to the accompanying drawings.

### BRIEF DESCRIPTION OF THE DRAWINGS

For a detailed description of the embodiments of the bit and design method disclosed herein, reference will now be made to the accompanying drawings in which:

FIG. 1 is a perspective view of an embodiment of a fixed cutter bit designed and made in accordance with the principles described herein;

FIG. 2 is a plan view of the bit shown in FIG. 1 as viewed from the borehole bottom;

FIG. 3 is a schematic view showing primary and backup cutter elements positioned on one blade of the bit shown in FIGS. 1 and 2;

FIG. 4 is a schematic elevation view showing the rotated profile of cutter elements mounted on a blade and having their initial, baseline placement parameters;

FIG. 5 is a schematic elevation view showing the relative positions of the cutting tips of a primary and a backup cutter element for the blade shown in FIGS. 3 and 4:

FIGS. 6A and 6B are schematic representations showing the relative radial positions and cutting paths of a primary and a backup cutter element for the blade shown in FIGS. 3 and 4;

FIGS. 7A, 7B and 7C are side elevation schematic views showing a back up cutter element for the blade shown in FIGS. 3 and 4 positioned to have, respectively, negative, zero and positive backrake.

FIGS. 8A and 8B are schematic representations showing the relative siderake angles and cutting paths of a primary and a backup cutter element for the blade shown in FIGS. 3 and 4.

FIG. 9 is a flow diagram illustrating steps in designing a bit using methods and principles described herein.

FIG. 10 is a schematic representation illustrating the initial, baseline cutting structure for a bit in which the primary cutter elements and backup cutter elements are provided with initial placement parameters.

FIG. 11 is a graph representing the resultant force on the primary and backup cutter elements for a bit cutting structure designed in accordance with the principles described herein.

FIG. 12 is a graph illustrating the out-of-balance force on a drill bit having the baseline cutting structure shown in FIG. 10.

FIG. 13 is a graph, similar to FIG. 12, showing the out-of-balance force on the cutting structure shown in FIG. 10 after the placement parameters of the backup cutter elements have been adjusted.

FIG. 14 is a schematic view of the bit shown in FIGS. 1 and 2 with the blades and select primary cutter elements shown in a rotated profile view.

### DETAILED DESCRIPTION OF DISCLOSED EMBODIMENTS

Many factors relating to the design of a fixed cutter drill bit will affect bit performance and how well the bit will meet particular design criteria. For example, the position and orientation of the cutter elements will impact specific criteria, such as the resultant force applied to each cutter element and the overall out-of-balance force seen by the bit, as well as other criteria. In turn, these can affect the bit's ROP and its durability. The methods described herein are directed to an iterative process by which the placement parameters (e.g., tip height or tip offset, radial position, backrake angle, siderake angle, and angular position) for backup cutter elements are varied while the placement parameters for the primary cutter elements remain at their initial or baseline values. Varying the placement parameters of backup cutter elements provides a means to optimize a cutting structure in an effort to achieve a better performing bit.

The following description is exemplary of embodiments of the invention. These embodiments are not to be interpreted or otherwise used as limiting the scope of the disclosure, including the claims. One skilled in the art will understand that the following description has broad application, and the discussion of any embodiment is meant only to be exemplary of that embodiment, and is not intended to suggest in any way that the scope of the disclosure, including the claims, is limited to that embodiment.

The drawing figures are not necessarily to scale. Certain features and components disclosed herein may be shown exaggerated in scale or in schematic form, and some details of conventional elements may not be shown in interest of clarity and conciseness.

The terms “including” and “comprising” are used herein, including in the claims, in an open-ended fashion, and thus should be interpreted to mean “including, but not limited to . . . .” Also, the term “couple” or “couples” is intended to mean either an indirect or direct connection. Thus, if a first component couples or is coupled to a second component, that connection may be through a direct engagement between the two components, or through an indirect connection, via other intermediate components, devices and/or connections.

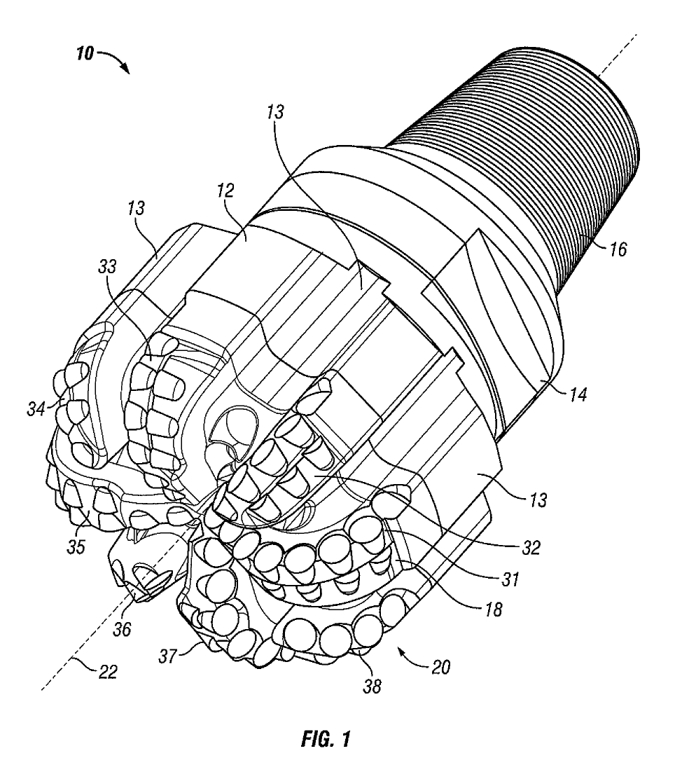

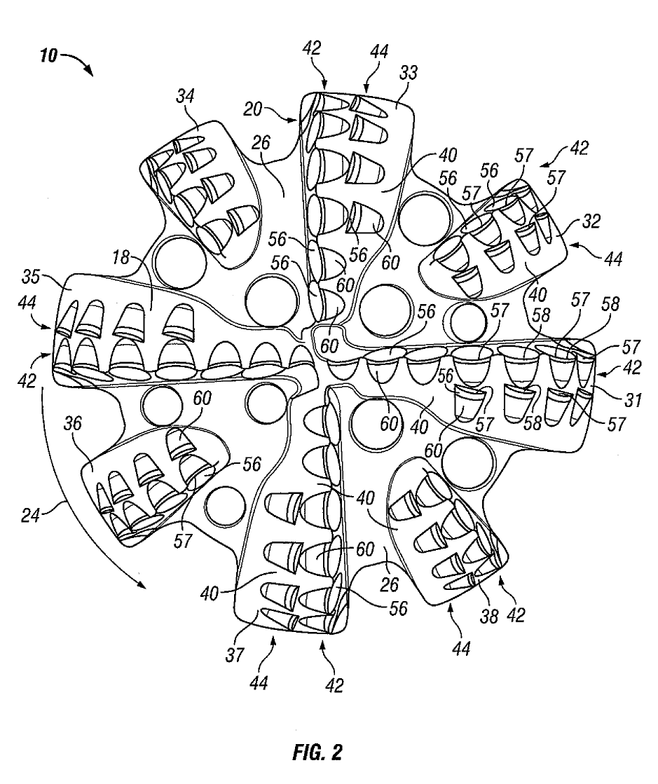

Referring to FIGS. 1 and 2, shown is exemplary bit 10 that is useful in describing the design methods disclosed. Bit 10 is a fixed cutter bit and generally includes a bit body 12, a shank 14 and a threaded pin 16 for connecting bit 10 to a drill string (not shown) which is employed to rotate the bit. Formed opposite pin end 16 is bit face 18 that supports cutting structure 20. Bit 10 further includes a central axis 22 about which bit 10 rotates in the cutting direction represented by arrow 24. As used herein, the terms “axial” and “axially” mean generally along or parallel to a given axis (e.g., bit axis 22), while the terms “radial” and “radially” mean generally perpendicular to the axis. Further, an axial distance refers to a distance measured along or parallel to the axis, and a radial distance means a distance measured perpendicular to the axis.

In the embodiment illustrated in FIGS. 1 and 2, cutting structure 20 includes eight angularly-spaced blades 31-38 which are integrally formed as part of, and extend along, bit face 18. In this embodiment, blades 31-38 are angularly spaced apart about 45 degrees and are separated by drilling fluid channels 26. Bit 10 further includes gage pads 13 of substantially equal axial length. Gage pads 13 are disposed about the circumference of bit 10 at angularly spaced locations. Gage pads 13 intersect and extend from each blade 31-38, and are integrally formed as part of the bit body 12.

Each blade 31-38 includes a cutter-supporting surface 40 for mounting a plurality of primary cutter elements 52 and a plurality of backup cutter elements 54. As best shown in FIG. 2, when bit 10 rotates about central axis 22 in the direction represented by arrow 24, a primary cutter element 52 leads or precedes each backup cutter element 54 positioned on the same blade 31-38. Thus, as used herein, the phrase “backup cutter element” refers to a cutter element that is disposed behind and trails another cutter element disposed on the same blade when the bit (e.g., bit 10) is rotated in the cutting direction (e.g., cutting direction 24) about its axis (e.g., bit axis 22). Further, as used herein, the term “primary cutter element” refers to a cutter element that is not disposed behind and does not trail any other cutter elements on the same blade when the bit is rotated in the cutting direction about its axis. Primary cutter elements 52 are arranged adjacent one another in a leading or primary row 42 that extends radially along the leading edge of each blade 31-38, and backup cutter elements 54 are arranged adjacent one another in a trailing or backup row 44 positioned behind primary row 42. Although primary cutter elements 52 and backup cutter elements 54 are shown as being arranged in rows, the design methods described herein may be employed on fixed cutter bits where cutter elements 52, 54 are mounted in other arrangements, provided each primary cutter element is in a leading position and each backup cutter element is in a trailing position on a blade.

As best shown in FIG. 2, each cutter element 52, 54 includes a cutting face 56 that is bonded or otherwise coupled to an elongated and generally cylindrical support member or substrate 60 which is received and secured in a pocket formed in the surface 40 of the blade to which it is fixed. Cutting face 56 is made of a very hard material such as polycrystalline diamond or other superabrasive material. As shown in FIGS. 1 and 2, each cutter element 52, 54 is mounted such that its cutting face 56 is forward-facing. As used herein, “forward-facing” is used to describe the orientation of a surface that is generally perpendicular to or at an acute angle relative to the cutting direction of rotation of the bit to which it is mounted. For example, a “forward-facing” cutting face 56 may be oriented perpendicular to the cutting direction of bit 10 represented by arrow 24, may include a backrake angle, and/or may include a siderake angle, described more fully below. In addition, each cutting face 56 includes a cutting edge 57 adapted to engage and remove formation material primarily via a shearing action. Such cutting edge 57 may be chamfered or beveled as desired. In this embodiment shown in FIGS. 1 and 2, cutting faces 56 are substantially planar, but may be convex or concave in other embodiments. As best shown in FIG. 4, each cutting face 56 has an outermost cutting tip 58 positioned furthest from cutter-supporting surface 40 of the blade to which it is mounted (as measured substantially perpendicularly from supporting surface 40).

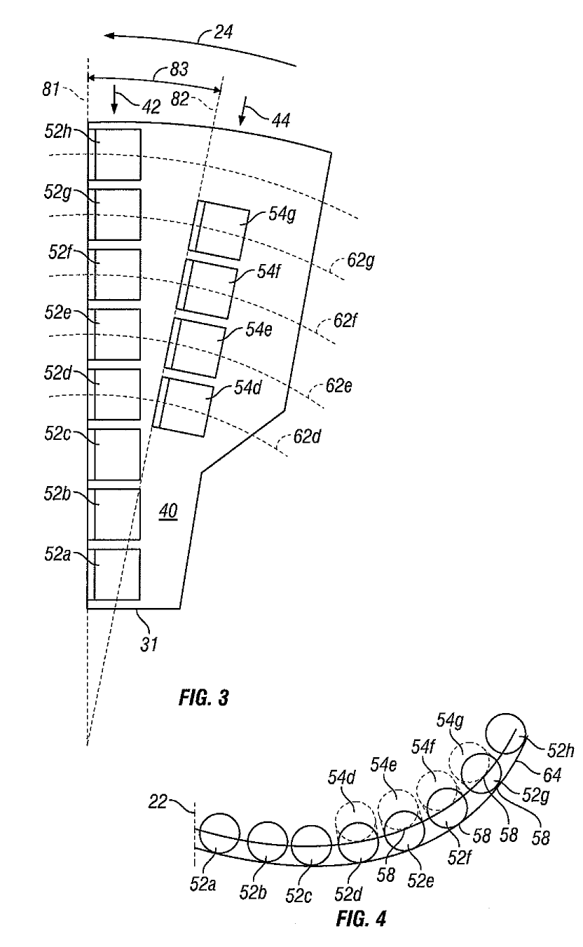

The arrangement by which backup cutter elements 54 trail behind corresponding primary cutter elements 52 is best described with reference to FIG. 3 which schematically shows primary row 42 and backup row 44 of blade 31. The principles described herein with reference to blade 31 are applicable to all blades 31-38. Referring then to FIG. 3, primary cutter elements 52a-52h of row 42 are positioned along the leading edge of blade 31. Backup row 44 includes four backup cutter elements 54d-54g which, respectively, trail behind primary cutter elements 52d-52g. In the embodiment shown, primary cutter elements 52d-52g travel along circular path 62d-62g, respectively. Further, in this exemplary embodiment, backup cutter elements 54d-54g travel along the same cutting paths 62d-62g, respectively and are positioned substantially at the same radial position as corresponding primary cutter elements 52d-52g.

Referring to FIG. 4, the cutting profile for all cutter elements 52-54 on blade 31 are shown as they would appear having been assigned their initial or “baseline” placement parameters. That is, they are shown as they would appear prior to undergoing the design methodologies described below. As shown, the cutting tips 58 of the primary cutter elements 52a-52h extend along a primary cutting profile 64. Although cutter elements 52a-52h do not themselves cut all the formation along primary cutting profile 64, the primary cutter elements 52 on the other seven blades 32-38 follow behind blade 31 and cut the formation that is “missed” by the primary cutter elements 52a-52h on blade 31, such that the bit 10 as a whole generally cuts along primary profile 64. Shown in FIG. 4 in dashed lines are the cutting profile of backup cutter elements 54d-54g. In this example, the cutting tips 58 of backup cutter elements 54d-54g do not extend to primary cutting profile 64, but are instead “offset” a predetermined distance. Again, in this embodiment, the backup cutter elements 54d-54g themselves create a backup cutting profile 66 that is spaced apart from primary cutting profile 64. As used herein, “tip height” of a cutter elements means the distance from a cutter element's cutting tip 58 measured from the blade's cutting supporting surface 40 as measured normal to that surface. Thus, in the arrangement of cutting structure 20 of bit 10 shown in FIG. 4, the tip height of backup cutter elements 54 is less than the tip height of primary cutter elements 52. Expressed another way, the cutting tips 58 of backup cutter elements 54 are “offset” from the position to which the cutting tips of primary cutter elements 54 extend by a distance referred to herein as the “tip offset.” Although primary and backup cutter elements 52, 54 are depicted in FIG. 4 as having substantially the same size and geometry, the design methods described herein may be employed in fixed-cutter bits in which the size and geometry of the primary cutter elements and secondary cutter elements 54 are not uniform. As one example, each backup cutter element 54 may have the same size and geometry, and each primary cutter element 52 may have the same size and geometry, but that are different from the size and geometry of the backup cutter elements.

Given the cutting structure 20 thus described, it will be understood that, as between a primary cutter element 52 and a backup cutter element 54 on the same blade, the primary element will be subject to substantially higher loading and will perform substantially greater cutting duty, at least until significant wear to the primary cutter element 52 occurs. This is because cutter element 54 trails closely behind the primary cutter element 52, is positioned at substantially the same radial position, but has a cutting tip that is less exposed to the formation (i.e., its tip height is less than the tip height of the primary cutter 52). In one conventional design, backup cutter elements have been positioned and oriented to perform in the sense of a “spare” cutter element that does not significantly engage the formation or perform significant cutting duty until the primary cutter element which it is following becomes worn or damaged. In particular, and referring to FIGS. 3 and 4, the cutting path of backup cutter elements 54 at least partially overlaps with the cutting path of primary cutter elements 52. Since backup cutter elements 54 trail primary cutter elements 52 on the same blade, they generally engage the formation to a lesser degree than the primary cutter elements 52 because the primary cutter element 52 has preceded it and already at least partially cleared-away the formation material from the path of back-up cutter element 54. However, in the event that a primary cutter element 52 wears or becomes damaged, the trailing backup cutter element 54 may take over the cutting duty of the worn or damaged primary cutter element 52, enabling drilling with bit 10 to continue.

In conventional bit design, a common method is to define initial placement parameters for the primary cutter elements in order to optimize one or more design criteria, and then to provide backup cutter elements that have a uniform degree of tip height, radial position, backrake and siderake without considering the effects that such placement parameters might have on the primary cutter elements. In such designs, although each backup cutter element played a role in the resultant force experienced by the primary cutter elements, the overall out-of-balance force on the bit, as well as other design criteria, the uniform placement parameters assigned to the backup cutter elements did not offer a means to optimize the cutting structure to achieve a design criteria.

In a design method disclosed herein, beginning with a baseline cutting structure where the primary cutter elements 52 and the backup cutter elements 54 each have a predetermined initial set of placement parameters, the bit performance may be evaluated via drilling simulations to generate values of design criteria of interest, such as the resultant force on each cutter element, the overall out-of-balance force on the bit, resistance to slip stick, and resistance to bit vibration. Thereafter, the generated values for the design criteria of interest are compared against predetermined values. Then, by redefining the placement parameters for certain or all of the backup cutter elements 54, a new cutting structure can designed and then tested in a drilling simulation to determine the “new” values for the design criteria of interest. In an iterative process, the placement parameters of one or more of the backup cutters 54 may be varied and the results compiled such that, ultimately, through the iterative process, an optimum backup cutting structure may be created without having to alter the placement parameters of the primary cutter structure. Specific placement parameters will now be described.

### Tip Height/Tip Offset

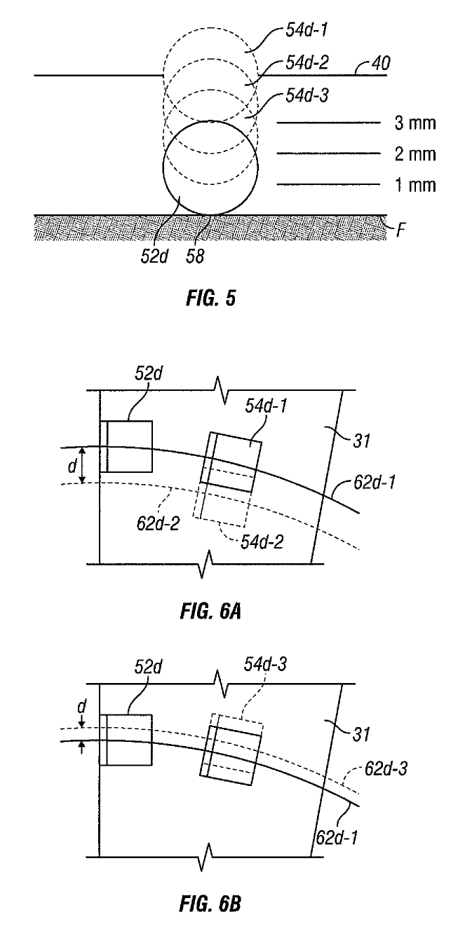

The cutting profiles of primary cutter element 52d and backup cutter element 54d of blade 31 are shown in FIG. 5, Primary cutter element 52d has an initial placement parameter by which its cutting tip 58 engages the formation designated as F. In this example, primary cutter element 52d has a tip height equal to 4 mm. By contrast, the cutting tip 58 of backup cutter element 54d is shown in three possible positions where, in each instance, the tip 58 of cutter element 54 is offset from the position of cutting tip 58 of primary cutter element 52. In an initial or baseline placement represented by position 54d-1, backup cutter element 54d is shown having its cutting tip 58 positioned 3 mm from the formation and only 1 mm distant from supporting surface 40. During the design process, it may be determined that it is desirable to reduce the tip offset and to bring the tip height of backup cutter element 54d to be closer to the tip height of primary cutter element 52d. Thus, during the design process, the cutting profile of cutter element 54d is moved closer to the formation, to the position shown by position 54d-2 in which the cutting tip height is 2 mm from supporting surface 40 and 2 mm from thr formation F. In a still further example, in the design process, it may be desirable to move the cutting tip 58 of backup cutter element 54d to the position shown in FIG. 5 as 54d-3, in which the cutting tip height is 3 mm from the supporting surface 40 and only 1 mm offset from the position of tip 58 of primary cutter element 52d. In a general sense, moving the cutting tip 58 of backup cutter element 54d closer to the formation, and thus increasing its tip height, will have the effect of relieving primary cutter element 52d of some of the cutting load and lowering the resultant force on the primary cutter element 52d, at least in the case where all other placement parameters for all other cutters 52, 54 remain unchanged. In this example, although the forces on the backup cutter element 54d will be increased relative to what they were before increasing its tip height, the resultant force on primary cutter element 52d may be significantly lessened while the force on the backup cutter element 52d is only moderately increased. Thus, such an adjustment in placement parameters (e.g., tip height in this example) of the backup cutter elements has potential for providing a more durable cutting structure, given that the resultant force is lessened on the primary cutter element 52, the cutter element first seeing the formation and responsible for greater cutting duty, at least prior to significant wear.

### Radial Position

Each primary and backup cutter element 52, 54 is also provided with an initial radial position. Varying the radial position of the backup cutter element 54 relative to its corresponding primary cutter element 52 may, like tip height, impact design criteria, such as the resultant force on the bit's cutter elements 52, 54 and also affect the total out-of-balance force seen by bit 10. Accordingly, iteratively varying the radial position of each backup cutter element 54 relative to its corresponding primary cutter element 52, running drilling simulations, and comparing generated values of certain criteria, such as resultant force and out-of-balance force, may, in turn, provide enhancements in ROP, bit durability or both,

Referring to FIG. 6A, initial cutting path 62d-1 taken by primary cutter element 52d and of backup cutter element 54d is shown. In this example, backup cutter element 54d has a baseline placement parameter by which it has substantially the same radial position as the primary cutter element 52d. Under this initial design, the position of backup cutter element 54 is represented by 54d-1. When a simulation is run for a given formation, the bit designed with the backup cutter element in position 54d-1 will yield the first set of generated values for resultant force on cutters 52, 54 and out-of-balance force on bit 10. Thereafter, according to the design process disclosed herein, the radial position of backup cutter element 54d can be changed and, in the example shown in FIG. 6A, is moved radially inward a distance d to the position shown in the dashed lines as 54d-2. In this example, d may be equal to 0.1 mm. In other examples, the radial position of cutter element 54d may be moved radially inward still further, for example, radially inward 0.2 mm or 0.3 mm from its initial placement position 54d-1. In the position shown as 54d-2, the cutter element 54d will move along circular cutting path 62d-2, and thus its cutting path is offset a distance d from what it had been when in position 54d-1. In other embodiments, as shown in FIG. 6B, it may be advantageous to move the radial position of backup cutter element 54d radially outward a distance d to the position shown by dashed line position 54d-3, where the backup cutter element will travel along cutting path 62d-3. As in the example above shown in FIG. 6B, the radial position of backup cutter element 54d may be moved 0.1 mm, 0.2 mm or 0.3 mm radially outward, and each position used in the simulation to determine in an iterative manner the effect on design criteria of interest, such as resultant force on each cutter 52, 54 and the overall out-of-balance force on bit 10.

### Backrake

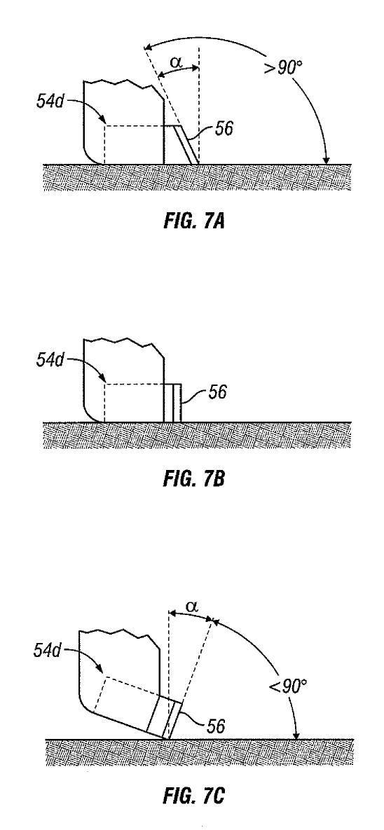

Referring to FIGS. 7A-C, backup cutter element 54d is shown mounted on a bit with its cutter face having three different backrake angles (primary cutter element 52d not depicted for purpose of clarity). The backrake angle of the cutting face on a cutter element may generally be defined as the angle α formed between the cutting face of the cutter element and a line that is normal to the formation material that is being cut. As shown in FIG. 7B, with a cutting face having zero backrake angle, the plane defined by the cutting face is substantially perpendicular or normal to the formation material. As shown in FIG. 7A, the cutter element having a negative backrake angle α has a cutting face that engages the formation at an angle that is greater than 90° as measured from the formation material. As shown in FIG. 7C, a cutter element having a positive backrake angle α has a cutting face that engages the formation material at an angle that is less than 90° as measured from the formation material. The backrake angle of the cutter element influences the forces applied to the cutter element. For example, assuming all other factors equal, the resultant force on the cutter element 54d in FIG. 7A will be greater than the resultant force on the cutter element of FIG. 7B, and the resultant force on the cutter element of FIG. 7B will be greater than the resultant force on the cutter element of FIG. 7C.

Varying the backrake angle of backup cutter elements 54 can again affect the resultant force on the cutter elements 52, 54, the total out-of-balance force on bit 10, and other design criteria.

According one of the methods described herein, a backup cutter element 54d corresponding to a primary cutter element 52d will be assigned initial backrake of, for example, a +5° as shown in FIG. 7C. Thereafter, the drilling simulation will be run and the resultant force on the individual cutter elements 52, 54 and the total out-of-balance force on the bit 10 will be determined. Iteratively, the backrake angle of backup cutter elements 54 will be changed in predetermined increments, for example, 5°. For example, the backrake angle of backup cutter element 54d may be changed to have the 0° backrake, as shown in FIG. 7B, and the drilling simulation run again to determine its effect on the resultant force on the cutters 52, 54, the out-of-balance force on the bit 10, and other design criteria of interest.

### Siderake

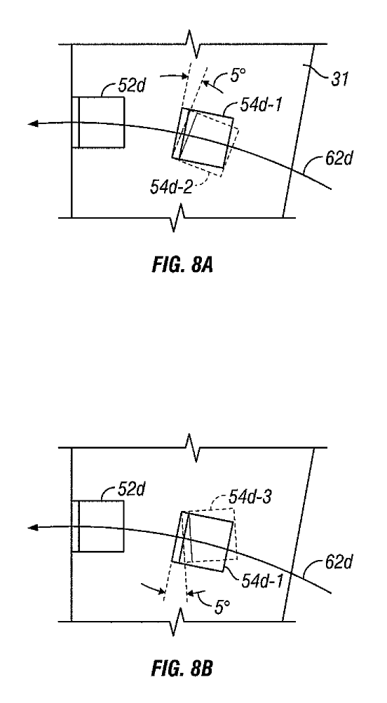

The siderake angle exhibited by a backup cutter element 54 is also a placement parameter that may be iteratively adjusted and its effect compared in simulations. Referring to FIG. 8A, primary cutter element 52d and corresponding backup cutter element 54d are shown having a set of initial or baseline placement parameters and traveling along cutting path 62d in this example. As an initial placement parameter, backup cutter element 54d may be assigned a 0° siderake, thus taking the orientation shown by the cutter element 54d-1 drawn with solid lines. In a next iteration, the siderake of cutter element 54d may be changed to correspond to position 54d-2 shown by the dashed lines, in which the siderake angle of cutter element 54d is, in this example, equal to 5°. Similarly, as shown in FIG. 8B, a second example is shown in which the siderake angle of cutter element 54d is changed in a further iteration to be equal to −5° as represented by position 54d-3 shown in dashed lines. The siderake may be changed by a predetermined increment of 1, 2 or more degrees, positive or negative, and with each iteration, the effect that the change has had on a design criteria of interest is determined (e.g. the resultant force on each cutter element 52, 54 and the overall out-of-balance force on the bit 10 is calculated).

### Angular Position

The angular position of a back up cutter element 54 relative to a primary cutter element 52 is best understood with reference again to FIG. 3. In the embodiment shown, the primary cutter elements 52a-52h are positioned on blade 31 such that their cutting faces extend along a line 81 that generally coincides with the front of blade 31. Back up cutter elements 54d-54g are positioned in the trailing positions shown, and have their cutting faces extending generally along line 82. The angle 83 formed between lines 81 and 82 is approximately 10 degrees in this exemplary embodiment such that, in this example, cutter elements 54d-54g are at angular positions that trail primary cutter elements 52d-52g by about 10 degrees. It is to be understood that angle 83 may differ from this measure from blade to blade on bit 10 and further that the angular position of each back up cutter element relative to a primary cutter element on a blade may vary along the length of a back up row 44. For example, and still referring to FIG. 3, in another arrangement, the angular position of back up cutter 54d may trial primary cutter 52d by about 5 degrees, while cutter Mg trails primary cutter element 52g by about 10 degrees. Changing the angular position of a back up cutter element from an initial position to a new position during bit design, while keeping other placement parameters unchanged, will cause the backup cutter element 54 to see a different cutting path than it did when positioned at the initial angular position. Accordingly, angular position is another placement parameter that can be varied to affect various design criteria and to optimize a cutting structure for a particular application.

### Optimization

Exemplary bit 10, described above, includes twenty-four backup cutter elements 54. Further, as discussed above, associated with each cutter elements are at least five placement parameters: tip height, radial position, backrake angle, siderake angle, and angular position. Further, for each placement parameter, there are multiple values that may be applied. For example, with respect to tip height, depending on the diameter of the bit, the diameter of the cutter element, the formation being drilled and other factors, the tip height of a backup cutter element 54 may be adjusted to three or more positions. Likewise, subject to certain dimensional constraints, radial position of the backup cutter 54 may typically be moved radically inward or radially outward a millimeter or two in each direction (as examples). As will thus be understood, the number of permutations (twenty-four backup cutter elements, considering only five placement parameters, with several possibilities for each placement parameter) leads to an extremely large number of placement parameter combinations that can be employed. Such a large number of combinations is most effectively evaluated by means of a computer. Thus, the methods contemplated herein utilize iterative design technologies to first establish, and then test in drilling simulations, cutting structures to achieve the design criteria, and to do so prior to going to the great expense of manufacturing a test bit. According to these methods, a baseline or initial cutting structure is first defined in which each primary cutter element 52 and backup cutter element 54 is assigned initial or baseline placement parameters. The initial placement parameters for primary cutter elements 52 will remain unchanged during this exemplary design process. With the initial placement parameters for primary and backup cutter elements 52, 54 established, the program will generate baseline values for various design criteria of interest, such as a baseline resultant force on each cutter element 52, 54 and a baseline out-of-balance force for the bit 10. Thereafter, the placement parameters of one or more of the backup cutter elements 54 are changed, iteratively, in order to determine the effect on the design criteria of interest (in this example, resultant force on each cutter element 52, 54 and the overall out-of-balance force on the bit 10) for each iteration. More specifically, after baseline values are determined, one placement parameter for one backup cutter element 54 is varied from the initial or baseline placement parameter, and the resultant force on the cutter elements 52, 54 and the overall out-of-balance force on the bit 10 calculated, with the results stored in memory. In a next iteration, another placement parameter is varied for a backup cutter element 54 with the drilling simulation then being run with the revised placement parameters. This will generate new data with respect to resultant force on the cutter elements 52, 54 and the out-of-balance force on the bit 10, with those values again being stored in memory. This process may continue until each placement parameter (taken alone or in combination) for each backup cutter element 54 has been run in the simulation, or until enough have been run to determine placement parameters that will yield a bit that meets particular design criteria. From the data now in memory, the designer can make narrowing choices in order to choose those combinations of placement parameters yielding desirable or at least acceptable resultant forces on cutter elements 52, 54 and out-of-balance force on bit 10.

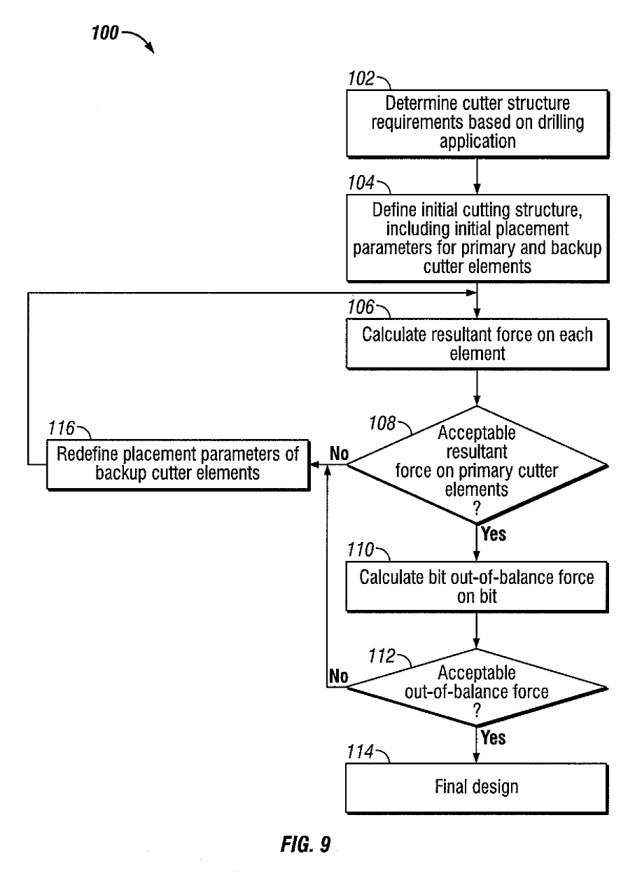

Referring to FIG. 9, one application of the bit design method is shown. This exemplary design process 100 begins at step 102 with an initial determination as to the basic parameters for the bit and its cutting structure that will be based on the requirements of the drilling application. These basic input parameters for the initial drill bit design include, for example, bit diameter, number and spacing of blades, and number and size of cutter elements (per bit and per blade), and other determinations. The initial input parameters are typically based on the designer's knowledge of preexisting bit designs, and how successfully/unsuccessfully those bit and cutting structure designs have performed in similar drilling applications as the one for which the new bit is to be designed.

The design process next includes an initial definition of placement parameters for all cutter elements 52, 54 in step 104. An automated bit design tool is used to create a bit design file in which the placement parameters for each cutter element are defined. The bit design tool may comprise menu-based input prompts and graphics generation routines that execute on a Microsoft Windows operating system. In one implementation, solid modeling computer aided design (CAD) software may be utilized. In step 104, each cutter element 52, 54 will be assigned a particular tip height, radial position, backrake, siderake, and angular position. In a drilling simulation, a calculation is then performed in step 106 to generate the resultant force applied to each primary cutter elements 52 and backup cutter element 54. It should be understood that certain aspects of the method disclosed herein may be defined and implemented in cooperation with kinematic force models such as that developed by Amoco Research and through other cutting analysis tools and graphics design programs run on personal computers or workstations. As already discussed, the forces on primary cutter element 52 will be substantially greater than those of the corresponding backup cutter elements 54; however, the resultant force on each backup cutter element 54 is also calculated in order to ultimately calculate the out-of-balance force on the bit in step 110, discussed below. Techniques for determining resultant force on individual cutter elements and a resultant out-of-balance force on bits are known, as described in U.S. Pat. Nos. 4,932,484, 5,010,789, 5,042,596, in U.S. Patent Application Publication No. US2009/0166091 A1, and in the published Sandia Report entitled “Development of a Method for Predicting the Performance and Wear of PDC Drill Bits” by David Glowka dated June 1987, the disclosures of which are all incorporated herein by this reference. With the resultant force on each cutter element 52, 54 calculated, the force is measured against a predetermined design criteria in step 108 to determine whether that resultant force is too high. That predetermined design criteria is based on prior calculations, lab tests, field tests and run data and will depend in part, on the strength of the materials employed in making the cutter elements, as one example.

If the resultant force on each primary cutter element 52 is acceptable, the out-of-balance force on the bit 10 is calculated in step 110. The output of the kinematic force model produces a total out-of-balance force vector. The total out-of-balance force on the bit is defined as the sum of the total radial and total drag forces for all the cutter elements, and can be expressed as a percentage of the weight on bit (WOB) by dividing the total imbalance force by the total WOB. Depending upon the drilling application, an out-of-balance force of a particular magnitude or force direction may be desirable or undesirable. For example, in many drilling applications, it is desirable that the resultant out-of-balance force be as low as possible. In certain directional drilling applications, force of a particular magnitude and directed towards a particular gauge pad is desired. In either instance, the calculated out-of-balance force is compared in step 112 to a predetermined design criteria for out-of-balance force. If the criteria is met, then the placement parameters defined in step 104 are passed on to be incorporated into the final design in step 114.

If after either calculation in step 106 or 110 the calculated forces are unacceptable because they do not meet the predetermined design criteria, then the design process moves to step 116 where, keeping the placement parameters of the primary cutter elements as initially defined in step 104 in this exemplary method, the placement parameters of backup cutter elements 54 are redefined and thus varied from their initial, baseline values. Following step 116, the method then recalculates the resultant forces on cutter elements 52, 54 and returns to step 106 after the placement parameters of backup cutter elements 54 have been redefined in step 116, and the process continues as described above. Although in this example, resultant force is calculated in step 106, and the calculation of out-of-balance force takes place in subsequent step 110, the order of these steps can be reversed.

In another example, in some instances, bit stability may be a critical design criteria, such that minimizing the overall out-of-balance force on the bit would be a primary goal of the design. In this example, the simulation program would run all possible combinations of placement parameters for the backup cutter elements 54 and rank the combinations from those generating in a simulation the lowest out-of-balance force to those having the highest out-of-balance force. Based on existing data or other studies by which a maximum resultant force on the cutter elements 52, 54 is determined, those combinations of placement parameters resulting in a low out-of-balance force, but where the predetermined maximum resultant force on the cutter elements was exceeded, would be discarded. Of those combinations/permutations remaining, the resultant force on the cutter elements 52, 54 would be less than the predetermined maximum, and so the combination exhibiting the lowest out-of-balance force (in this example), would be selected for the bit design, and a bit may be manufactured pursuant to that design.

In a variation of this method, there may be instances where a specific out-of-balance force may be desirable, as in directional drilling applications. In those instances, after eliminating the combinations in which the resultant force on the cutter elements 52, 54 exceed a predetermined maximum, the computer would sort the remaining combinations and choose the one generating the out-of-balance force that is closest to the out-of-balance force that is desired for the particular drilling application.

In another example, where the total out-of-balance force on the bit is not as important as avoiding designs having an excessive resultant force on a cutter element, the combinations would be run in a simulation and ranked to first eliminate all placement parameter combinations for backup cutter elements yielding a resultant force on any cutter element that exceeded a predetermined maximum. Then, the remaining combinations would be ranked by the computer from those having the lowest out-of-balance force to those having the highest. In applications where it is also desirable to have a low out-of-balance force, then the combination having the lowest out-of-balance force of those remaining combinations could then be selected for implementation, and the bit then manufactured in accordance with those placement parameters.

In another example of a design method disclosed herein, initial placement parameters for primary cutter elements and backup cutter elements are assigned, and a bit having that cutting structure is run in a simulation in order to determine the baseline resultant force on all cutter elements. Theoretically, the most efficient loading distribution would be to load all the primary cutter elements 52 in a particular region of the bit equally, so that the design would be less likely to overload any single cutter element in that region. For example, and referring to FIG. 3, primary cutter elements 52d and 52e generally are positioned in the nose region of bit 10. In this example, the placement parameters for the backup cutter element 54d and 54e in the nose region of the bit (and similarly positioned backup cutter elements 54 that are positioned on blades 32-38), would be adjusted in order to minimize the standard deviation between resultant force on the primary cutter elements 52 in the nose region. The combination of backup cutter element placement parameters which then yielded the minimum standard deviation of forces on the primary cutter elements 52 in the nose region could be selected. Although the loading on the backup cutter elements 54 in the nose region may be uneven, the forces on the primary cutter elements 52 in that region would be substantially higher, such that the uneven resultant forces on the backup cutter elements 54 would not be detrimental.

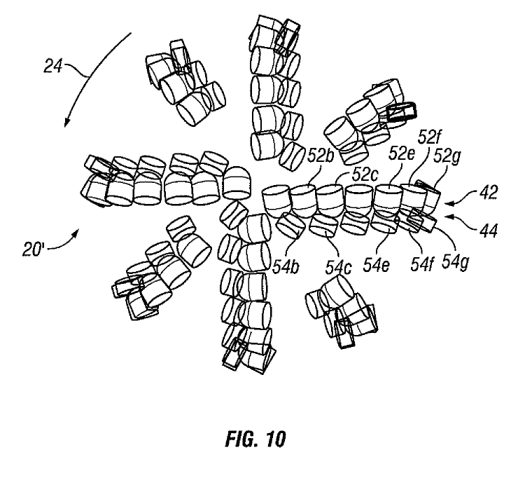

FIGS. 10-13 illustrate an example application of the above-described bit design process to yield a bit design suitable for a particular application. As discussed with reference to FIG. 9, an initial cutting structure is devised and initial requirements are established. In this example, a drill bit design includes a cutting structure 20′ that is similar but not identical to cutting structure 20 of bit 10 previously described with reference to FIGS. 1 and 2. Cutting structure 20′ is shown in FIG. 10 to have eight blades approximately 45° apart, with each blade including a primary row 42 of primary cutter elements 52 followed by a backup row 44 of backup cutter elements 54. In this example, the backup cutter elements 54 have tip heights that differ from the primary cutter elements by 1 mm, have 20° backrake, 0° siderake, and are angularly positioned a small distance behind the primary cutter elements 52. The radial position of the backup cutter elements 54 is substantially the same as their corresponding primary cutter elements 52. These placement parameters are referred to herein as the “baseline” placement parameters from which adjustments will be made in order to attempt to design a bit having more-preferred characteristics. In this example, the primary cutting structure was selected based on prior studies and bit evaluations from testing and actual field runs which yielded a primary cutting structure believed generally desirable for the new application for which the cutting structure and bit is now being designed.

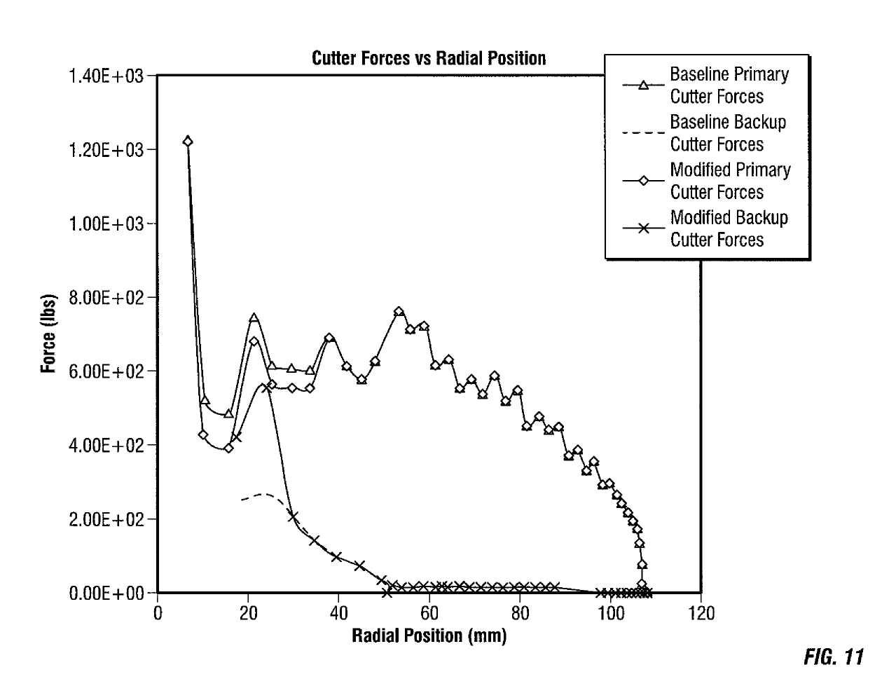

Referring to FIG. 11, according to the method described above, the tip height of the two backup cutter elements 54 shown in FIGS. 10 as 54b and 54c were adjusted such that they were moved 1 mm in this example to a position having zero tip offset, meaning that they were moved to have the same extension height as their corresponding primary cutter elements 52b, 52c, respectively. In accordance with this exemplary design method, the placement parameters of the primary cutter elements 52 were not changed, and the placement parameters of the other backup cutter elements 54 did not change.

FIG. 11 represents the resultant force on the primary and secondary cutter elements 52, 54 as a function of their radial position on bit face 18. In this example, the innermost primary and backup cutter elements are positioned at approximately 8 mm from the bit axis 22, and the outermost cutter elements being are positioned at approximately 114 mm from the bit axis 22. As shown, by adjusting only the tip height of only two backup cutter elements 54, the resultant force decreased on the primary cutter elements 52 located in radial positions from approximately 8-40 mm from the axis. This adjustment in backup cutter element placement parameters had little or no effect on resultant forces on the cutter elements 52 positioned further from the axis. As FIG. 11 shows, the resultant force on the innermost backup cutter elements 54 positioned at approximately 18-30 mm from the bit axis increased. In this example, however, the increase in resultant force on the backup cutter elements 54 is acceptable given the decrease in resultant force on the innermost primary cutter elements 52.

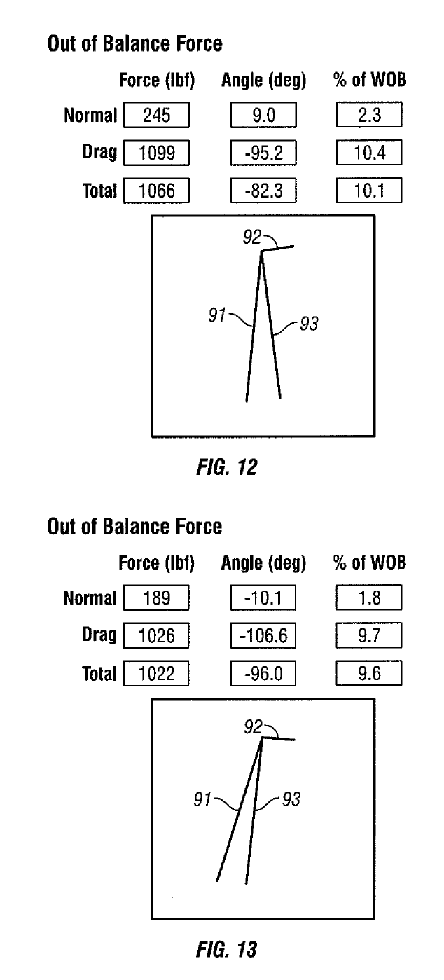

Referring to FIG. 12, the out-of-balance force on the bit having the cutting structure 20′ of FIG. 10 is illustrated. The graph illustrates the sum of the drag forces on the bit as vector 91 and the sum of the normal forces on the bit as vector 92. The sum of the drag forces and normal forces equal the out-of-balance force represented by vector 93. The out-of-balance force for the bit having the baseline cutting structure shown in FIG. 10 is 10.1% of the weight-on-bit.

Starting with the baseline cutting structure 20′ shown in FIG. 10, and adjusting the tip offset for a single backup cutter element 54c so as to move the tip closer to the tip of the corresponding primary cutter element 52c yields a change in forces applied to the bit. FIG. 13 illustrates that the normal, drag and total forces have changed. Specifically, the normal force on the bit shown by vector 92 summed with the drag force on the bit illustrated by vector 91 collectively provide a total out-of-balance force shown by vector 93. In this instance, the total out-of-balance force is 9.6% of weight-on-bit, yielding a 0.5% lower out-of-balance force compared to the baseline cutting structure with the baseline placement parameters.

As shown, adjustments to even a single placement parameter (in this example) of only a single secondary cutter element 54 can affect the resultant force on the primary cutter elements and the out-of-balance force on the bit. Varying more placement parameters and for more backup cutter elements 54 (even while keeping the placement parameters for the primary cutter elements 52 unchanged as in this example), provides the bit designer with the substantial opportunities to optimize the cutting structure and to enhance bit performance.

The bit design method has, to this point, been described most particularly in terms analyzing resultant force and how to balance force across the entire bit face. It should be understood that the methods described may also be applied to other design criteria of interest, such as slip stick and resistance to bit vibration. Further, these methods may be applied with respect to only certain regions of the bit, rather than to the entire bit face. In fact, it is typically the case that the highest resultant force is applied to primary cutter elements in the nose region of the bit, meaning that, if the placement parameters of backup cutter elements are adjusted to ensure that the resultant forces experienced by the primary cutter elements in the nose region are below a predetermined acceptable value, then the resultant forces on cutter elements in all other regions will likewise be below their acceptable values.

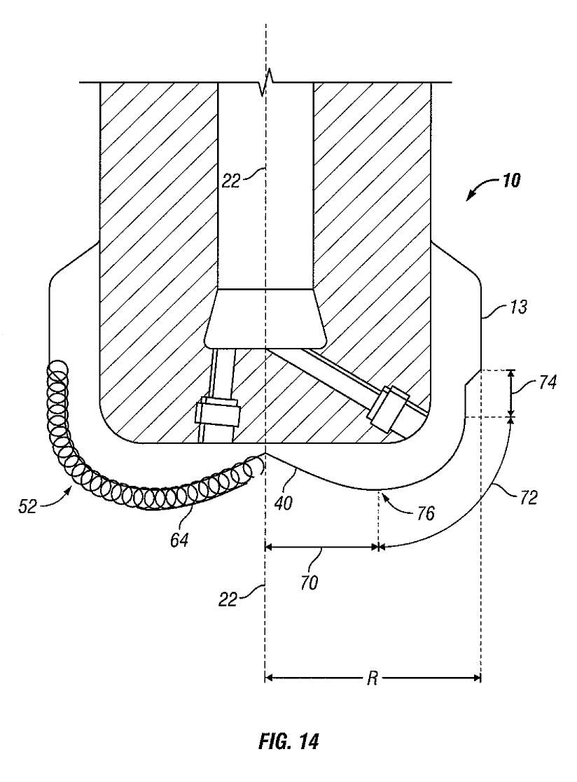

Referring momentarily to FIG. 14, the profile of bit 10 is shown as it would appear with all blades 31-38 and select primary cutter elements 52 rotated into a single rotated profile. Some primary cutter elements 52 are not shown in this view for clarity. Blades 31-38 of bit 10 form a combined or composite primary cutting profile 64 as earlier described. Primary cutting profile 64 and bit face 18 may generally be divided into three regions conventionally referred to as cone region 70, shoulder region 72, and gage region 74. Cone region 70 comprises the radially innermost region of bit 10 and of the primary cutting profile 64, and extends generally from bit axis 22 to shoulder region 72. In this embodiment, cone region 70 is generally concave. Adjacent cone region 70 is shoulder (or the upturned curve) region 72. In this embodiment, shoulder region 72 is generally convex. The transition between cone region 70 and shoulder region 72 occurs at the axially outermost portion of primary cutting profile 64 (lowermost point on bit 10 in FIG. 14), which is typically referred to as the nose 76. Next to shoulder region 72 is the gage region 74 which extends substantially parallel to bit axis 22 at the outer radial periphery of cutting profile 64. In this embodiment, gage pads 13 extend from each blade. As shown in cutting profile 64, gage pads 13 define the outer radius R of bit 10. Outer radius R extends to and therefore defines the full gage diameter of bit 10.

Accordingly, the method described herein may be applied, for example, only to the shoulder region 72 of the bit, or the nose portion 76 rather than the entire bit face 18. Using the shoulder region as an area of most interest in this example, then the same methodology explained with reference to FIG. 9 will be employed, except that the method would be applied only to the primary cutter elements 52 and secondary cutter elements 54 that are positioned in shoulder region 72. Applying the design method described herein in this more limited manner, the resultant force on the primary cutter elements in the shoulder region 72 would first be determined. The placement parameters of backup cutter elements would be varied during the design process, so as to yield resultant forces on each primary cutter element in shoulder region 72 that is below an accepted value.

Analyzing and optimizing the cutting structure in only a particular region may be appropriate where past history has shown cutter elements in that particular region being susceptible to breakage, but where cutter elements in other regions do not exhibit similar damage.

After it has been determined that the resultant force on all the primary cutter elements in the region of interest (here, the shoulder region 72) are below a predetermined maximum value, then the out-of-balance force on the entire bit can be evaluated to determine whether that design criteria is satisfied.

When varying a placement parameter of one of more back up cutter elements, it is to be understood that the methods disclosed herein allow for varying only some of the placement parameters, and varying placement parameters for only some back up cutter elements. Thus, for example, although some conventional bit designs incorporate back up cutter elements that all have the same tip height (for example), when redefining the placement parameters of the back up cutters to optimize certain criteria according to the teachings herein, it may be that one or more of the back up cutters have their tip height changed from their initial value to a new first value, while others are changed to a new second value that differs from the new first value, while still others remain unchanged. In other words, the methods disclosed herein do not require that the redefined placement parameters all be changed, or that they all be changed in a like manner or to a uniform value.

While preferred embodiments have been shown and described, modifications thereof can be made by one skilled in the art without departing from the scope or teachings herein. The embodiments described herein are exemplary only, and are not limiting. Many variations and modifications of the disclosed apparatus are possible and are within the scope of the invention. Accordingly, the scope of protection is not limited to the embodiments described herein, but is only limited by the claims that follow, the scope of which shall include all equivalents of the subject matter of the claims.

What is claimed is:

1. A method for designing a fixed cutter drill bit, comprising:
(a) defining initial placement parameters for a plurality of primary cutter elements and a plurality of backup cutter elements;
(b) applying to a simulated formation in a drilling simulation a drill bit having the defined initial placement parameters and producing a generated value of at least a first design criteria of interest;
(c) determining whether said generated value meets a predetermined value for said first design criteria;
(d) redefining at least one placement parameter of at least one of the backup cutter elements;
(e) applying to a simulated formation in a drilling simulation a drill bit having the redefined placement parameters and producing a new generated value for the said first design criteria;
(f) determining whether said new generated value meets the predetermined value;
(g) repeating steps (d) (e) and (f)

2. The method of claim 1 further comprising continuing to repeat steps (d), (e) and (f) at least until said new generated value meets the predetermined value of said first design criteria of interest.

3. The method of claim 1 further comprising continuing to repeat steps (d), (e) and (f) at least until a plurality of new generated values are determined that meet the predetermined value.

4. The method of claim 3 further comprising identifying the redefined placement parameters that provided said plurality of new generated values meeting the predetermined value of the first design criteria, and ranking them according to their associated generated values.

5. The method of claim 2 further comprising:
(h) after a new generated value is determined to meet the predetermined value of the first design criteria, selecting a second and different design criteria of interest;
(i) applying to a simulated formation in a drilling simulation a drill bit having the initial placement parameters of said primary cutter elements and the redefined placement parameters of said back up cutter elements that generated a value that met the predetermined value for the first design criteria, and producing a generated value of said second design criteria of interest;
(j) determining whether said generated value of said second design criteria of interest meets a predetermined value for said second design criteria;
(k) redefining at least one placement parameter of at least one of the backup cutter element;
(l) applying to a simulated formation in a drilling simulation a drill bit having the initial placement parameters of said primary cutter elements and the redefined placement parameters for the backup cutter elements of step (k), and producing a new generated value for the second design criteria of interest;
(m) determining whether said new generated value for the second design criteria of interest of step (l) meets the predetermined value for said second design criteria; and
(n) repeating steps (k), (l) and (m).

6. The method of claim 5 further comprising continuing to repeat steps (k), (l) and (m) at least until said new generated value of step (m) meets the predetermined value of said second design criteria of interest.

7. The method of claim 1 wherein said initial placement parameters of said primary cutter elements remain unchanged.

8. The method of claim 6 wherein said initial placement parameters of said primary cutter elements remain unchanged.

9. The method of claim 1 wherein steps (b) through (e) are performed for at least two design criteria of interest.

10. The method of claim 9 wherein said at least two design criteria of interest are resultant force on said cutter elements and the total out of balance force on the bit.

11. The method of claim 1 wherein the initial placement parameters of a first backup cutter element and a second backup cutter element are the same, and wherein the method further comprises:
redefining the placement parameters of said first and second backup cutter elements such that the redefined placement parameters of said first backup cutter element differ from the redefined placement parameters of said second backup cutter element.

12. The method of claim 3 further comprising:
eliminating from further design consideration all combinations of placement parameters yielding in the simulation a resultant force on a primary cutter element that exceeds a predetermined value, and thereafter calculating the bit out-of-balance force for a plurality of combinations that have not been eliminated.

13. A fixed cutter drill bit designed by a method comprising the method of claim 2.

14. A method for designing a fixed cutter drill bit having primary and back up cutter elements, comprising:
(a) defining initial primary placement parameters for a plurality of primary cutter elements;
(b) repeatedly: selecting back up placement parameters for a plurality of back up cutter elements; applying to a simulated formation a drill bit design having the combination of the defined initial primary placement parameters and the selected back up placement parameters; producing in the simulation using the combination a generated value representative of a first design criteria of interest; comparing the generated value to a first predetermined acceptable value.

15. The method of claim 14 wherein step (b) is performed at least until said generated value meets the first predetermined acceptable value.

16. The method of claim 14 wherein step (b) is performed at least until a plurality of combinations are found that generate a value that meets the first predetermined acceptable value.

17. The method of claim 15 further comprising:
(c) for a combination that produces a generated value that meets the first predetermined acceptable value, repeatedly: applying to a simulated formation a drill bit design having the combination; producing in the simulation using the combination a generated value representative of a second design criteria of interest; comparing the generated value of the second design criteria to a second predetermined acceptable value.

18. The method of claim 17 further comprising selecting for inclusion in a drill bit to be manufactured the combination generating a value that meets the first predetermined acceptable value and the second predetermined acceptable value.

19. The method of claim 14 wherein the design criteria of interest is one selected from the group consisting of resultant force on a cutter element, overall out-of-balance force on the bit, resistance to slip stick, and resistance to bit vibration.

20. The method of claim 14 wherein the first design criteria of interest is resultant force on cutter elements, and wherein the producing in the simulation of a generated value representative of a first design criteria of interest is conducted for a predetermined region on the bit that is less than the entire bit face.

21. The method of claim 17 wherein the initial primary placement parameters of the primary cutter elements remain unchanged.

22. A method of designing a fixed cutter drill bit, comprising the steps of:
(a) determining initial placement parameters for primary and backup cutter elements;
(b) calculating through a simulation the resultant force on each of the primary cutter elements in at least a given region on the bit;
(c) comparing the calculated resultant force on each primary cutter element in the given region to a predetermined acceptable value;
(d) adjusting at least one placement parameter for at least one backup cutter element without adjusting an initial placement parameter for a primary cutter element; and
(e) repeating steps (b) through (d) at least until the calculated resultant force on each primary cutter element in the given region is within acceptable limits.

23. The method of claim 22 further comprising the steps of:
(f) using a given set of placement parameters for primary and backup cutter elements, calculating in a simulation the out-of-balance force on the bit;
(g) comparing the calculated out-of-balance force on the bit to a predetermined acceptable out-of-balance force;
(h) creating a new set of placement parameters by adjusting at least one placement parameter for at least one backup cutter element without adjusting an initial placement parameter for a primary cutter element;
(i) using the new set of placement parameters, calculating the out-of-balance force on the bit;
(j) comparing the calculated out-of-balance force generated in step (i) to a predetermined criteria for acceptable out-of-balance force;
(k) repeating steps (h) through (j) at least until the calculated out-of-balance force on the bit is within the predetermined criteria for acceptable out-of-balance force.

24. A fixed cutter drill bit designed by a method comprising a method of claim 23.

25. The method of claim 22 wherein the step of adjusting placement parameters of backup cutter elements comprises redefining at least one placement parameter selected from the group consisting of tip height, radial position, backrake angle, siderake angle, and angular position.

26. The method of claim 22 wherein the step of adjusting comprises redefining the placement parameters of a first backup cutter element to have a first set of redefined placement parameters and redefining the placement parameters of a second backup cutter element to have a second set of redefined placement parameters, wherein the first set of redefined placement parameters is not identical to the second set of redefined placement parameters.

27. The method of claim 22 further comprising calculating the resultant force on each primary cutter element in the given region for every combination of placement parameters for the back up cutter elements.

28. The method of claim 22 further comprising eliminating from further design consideration all back up cutter element placement parameters yielding in the simulation a resultant force on a primary cutter element that exceeds a predetermined design criteria, and thereafter calculating the bit out-of-balance force for a plurality of combinations that have not been eliminated.
